(19) United States
(12) Patent Application Publication
(10) Pub. No.: US 2009/0241093 A1
(43) Pub. Date: Sep. 24, 2009

(54) METHOD FOR DEBUGGING PROGRAMMABLE LOGIC CONTROLLER

(75) Inventors: WEN-CHIH CHIU, Tu-Cheng (TW); CHAU-LIN CHANG, Tu-Cheng (TW); JHY-HAU CHIU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: FOXNUM TECHNOLOGY CO., LTD., Tucheng City (TW)

(21) Appl. No.: 12/195,437

(22) Filed: Aug. 21, 2008

(30) Foreign Application Priority Data
Mar. 21, 2008 (CN) 200810300648.5

(51) Int. Cl. G06F 9/44

(52) U.S. Cl. 717/126

(57) ABSTRACT

The present invention relates to a method for debugging a programmable logic controller. An invariant logic formula is set up. A program is checked by the invariant logic formula, and if the program satisfies the invariant logic formula, debugging is complete and the process returns to the program checking step. If the program does not satisfy the invariant logic formula, checking is stopped and a warning signal and position or timing of the program error are issued.

### BACKGROUND

1. Field of the Invention

The invention generally relates to debugging methods and, more particularly, to a method for debugging a programmable logic controller.

2. Description of Related Art

A programmable logic controller is a digital computer used in automation of industrial processes, such as control of machinery on factory assembly lines. The programmable logic controller is an example of a real time system since output results must be produced in response to input conditions within a limited time. While the fundamental concepts of programmable logic controller programming are common to all manufacturers, differences in input/output addressing, memory organization, and instruction sets mean that programmable logic controller programs are never perfectly interchangeable among different devices. Even within the same product line of a single manufacturer, different models may not be fully compatible.

The programs of the programmable logic controller are very complicated; input/output errors are difficult to locate and indentify, and debugging of them is equally laborious. When an element of an exterior input/output contact is activated, a corresponding figure of the program of the programmable logic controller is noted. The program of the programmable logic controller is also difficult to maintain because it has no module classification following compilation and most functions and relationships therein are hidden from the user.

What is needed, therefore, is a method for quickly and easily debugging a programmable logic controller.

### SUMMARY

A method for debugging a programmable logic controller is provided. In the present embodiment, the method includes setting up an invariant logic formula, which then checks a program. If the program satisfies the invariant logic, debugging is complete and the process returns to checking the program. If the program does not satisfy the invariant logic formula, program checking stops and a warning signal and position or timing of the error in the program are issued.

Advantages and novel features of the present method for debugging a programmable logic controller will become more apparent from the following detailed description of preferred embodiments when taken in conjunction with the accompanying drawings.

### BRIEF DESCRIPTION OF THE DRAWINGS

The components in the drawings are not necessarily drawn to scale, the emphasis instead being placed upon clearly of the principles of the present invention.

FIG. 1 is a flowchart of a method for debugging a programmable logic controller in accordance with a first embodiment of the present invention.

FIG. 2 is a schematic view of a series invariant logic formula in accordance with the first embodiment of the present invention.

FIG. 3 is a schematic view of a parallel invariant logic formula in accordance with the first embodiment of the present invention.

FIG. 4 is a schematic screen view of a programmable logic controller in accordance with the first embodiment of the present invention.

FIG. 5 is a flowchart of a method for debugging a programmable logic controller in accordance with a second embodiment of the present invention.

FIG. 6 is a schematic screen view of a warning signal of the programmable logic controller in accordance with the second embodiment of the present invention.

FIG. 7 is a flowchart of a method for debugging a programmable logic controller in accordance with a third embodiment of the present invention.

FIG. 8 is a schematic view of an emergency stop module in accordance with the third embodiment of the present invention.

Corresponding reference characters indicate corresponding parts. The exemplifications set out herein illustrate at least one preferred embodiment of the present method for debugging a programmable logic controller, in one form, and such exemplifications are not to be construed as limiting the scope of the invention in any manner.

### DETAILED DESCRIPTION OF THE EMBODIMENTS

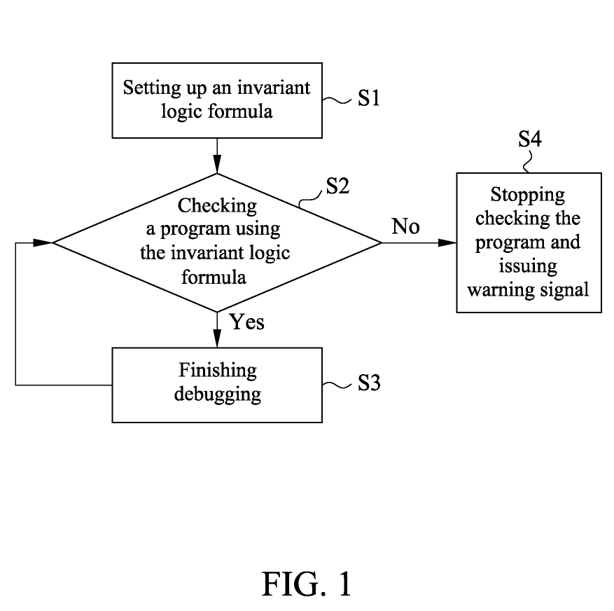

Referring to FIG. 1, a first embodiment of a method for debugging a programmable logic controller is provided. The method is implemented by using an invariant logic formula to monitor a program of the programmable logic controller. If the program of the programmable logic controller does not satisfy the invariant logic formula, the program has encountered an input/output signal error or a logic error. Information parameters for an exterior input/output contact, an interior assisting contact, a timer, and a counter are all established. All signal conditions are monitored. The method includes steps as follows.

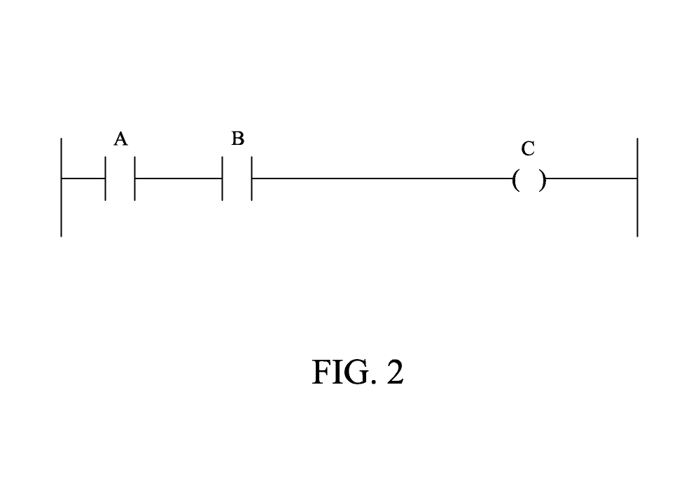

In Step 1, an invariant logic formula is set up, according to the invariant rule, that is, the result of all the input signals after compilation equals the result of all the output signals. The invariant logic formula includes a series logic (AND) and a parallel logic (OR). Referring also to FIG. 2, A or B is a signal of an exterior input/output contact, an interior assisting contact, a timer, or a counter. C is a signal of the output contact or an interior assisting contact.

The rule of the series logic satisfies the following formula:

(A&B)=C, wherein & is series logic (AND).

Setting up the series invariant logic formula satisfies the following formula:

(A&B)−C=0.

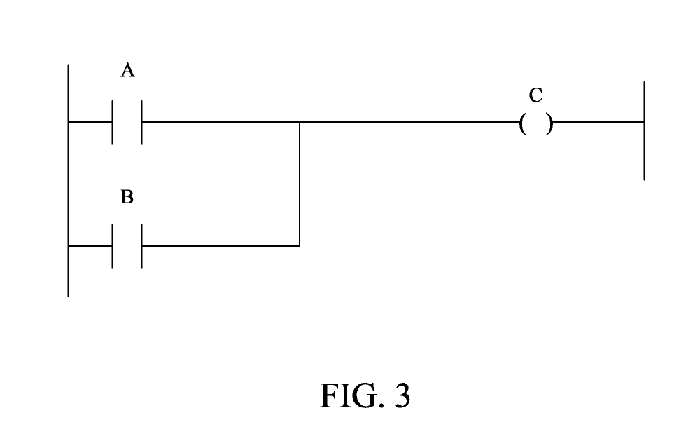

Referring to FIG. 3, the rule of the parallel logic satisfies the following formula:

(A|B)=C, wherein | is a parallel logic (OR).

Setting up the parallel invariant logic formula satisfies the following formula:

(A|B)−C=0.

In Step 2, a program is checked by the invariant logic formula. The program of the programmable logic controller is checked by the parallel invariant logic formula and series invariant logic formula.

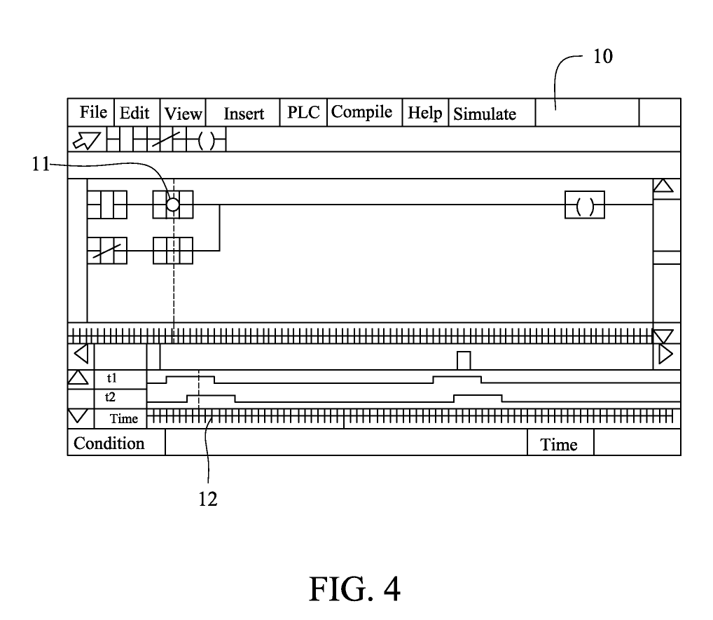

In Step 3, if the program satisfies the invariant logic formula, debugging is complete and the process returns to the program checking step 2. In Step 4, if the program does not satisfy the invariant logic formula, program checking stops and a warning signal and position and timing of the program error are issued. Referring to FIG. 4, the position 11 and timing 12 of the program error of the programmable logic controller is displayed on a human-machine interaction means 10 and saved in a buffer (not shown in FIG. 4).

It should be noted that the method uses an invariant logic formula to monitor a program of the programmable logic controller and provides quick and easy location of an input/output signal error or logic program error therein.

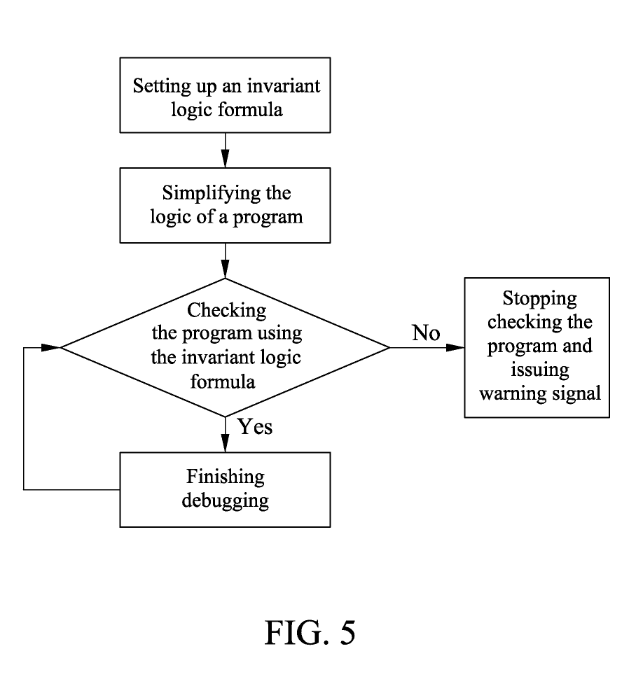

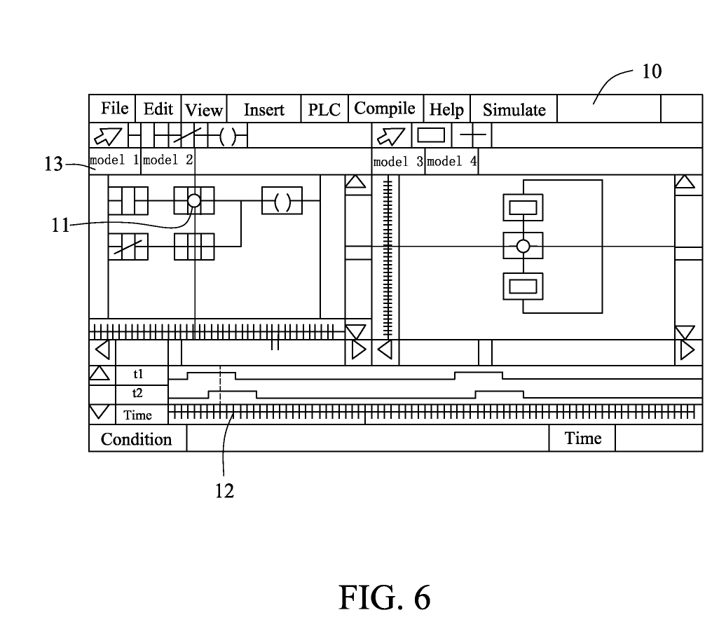

FIG. 5 illustrates a second embodiment of a method for debugging a programmable logic controller, differing from the previous embodiment only in that, here, a program classification step precedes the program checking step. The program classification step classifies the program of the programmable logic controller into many modules. Referring to FIG. 6, the different modules of the program are correspondingly shown on module page 13 of the human-machine interaction means 10 of the programmable logic controller. Because the program is classified into a plurality of modules, the program is easy to maintain and manage. The position 11 and timing 12 of the program error are displayed on module page 13 of the human-machine interaction means 10 of the programmable logic controller, such that input/output signal and logic errors in the modules are easy to locate and debug.

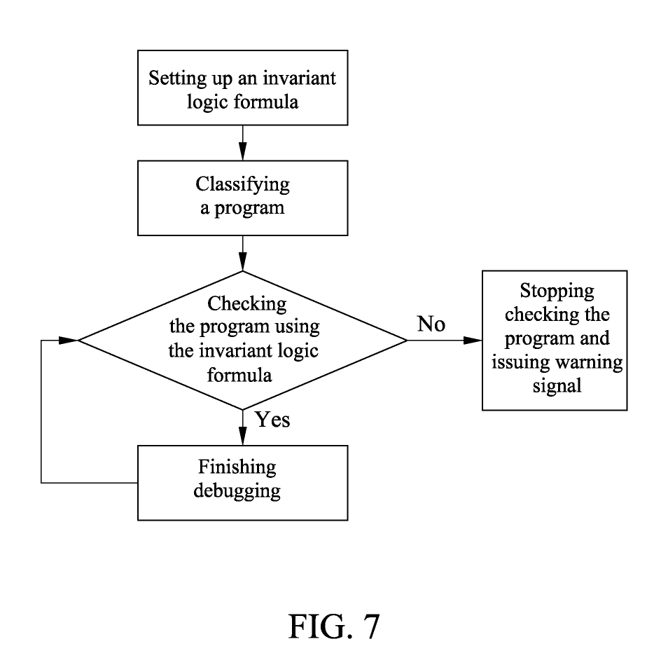

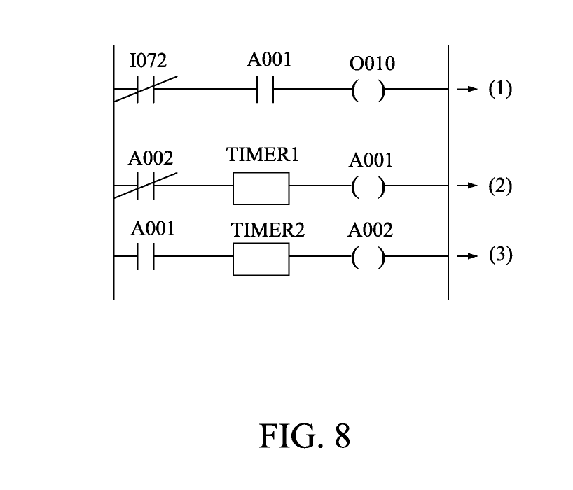

FIG. 7 illustrates a third embodiment of a method for debugging a programmable logic controller, differing from the previous embodiments only in that, before the program checking of step 2, the method further includes a step simplifying the logic of a program. The logic simplification step operates simultaneously with many logic formulae of the program. For example, referring to FIG. 8, an emergency stop module of a computer numerically controlled milling machine is shown. The emergency stop module is configured to generate a warning signal. I072 is a button switch of the emergency stop module. O010 is a button switch of the emergency stop module. A001 and A002 are an interior assisting contact of the emergency stop module. TIMER1 and TIMER2 are timers of the emergency stop module. The invariant logic formula of the emergency stop module is:

( I̅0̅7̅2̅&A001)−O010=0 (1),

( A̅0̅0̅2̅&TIMER1)−A001=0 (2),

(A001&TIMER2)−A002=0 (3), where I702 and A002 are normal close contacts. Because formulae (2) and (3) are interdependent, formula (2) operates simultaneously with formula (1). The invariant logic formula of the emergency stop module, after simplification, is:

( I̅0̅7̅2̅&( A̅0̅0̅2̅&TIMER1))−O010=0.

Accordingly, hundreds of input/output signals of the program to be monitored have been simplified to a few tens of invariant logic formulae. Thus, the logic simplification step reduces the loading of the programmable logic controller.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A method for debugging a program of a programmable logic controller, comprising:
setting up an invariant logic formula;
checking the program using the invariant logic formula; and
if the program satisfies the invariant logic formula, returning to the program checking step, and if the program does not satisfy the invariant logic formula, stopping program checking and issuing a warning signal.

2. The method for debugging a program of a programmable logic controller as claimed in claim 1, further comprising, before the program checking step, classifying the program into many modules.

3. The method for debugging a program of a programmable logic controller as claimed in claim 1, further comprising, before the program checking step, simplifying the program.

4. The method for debugging a program of a programmable logic controller as claimed in claim 1, wherein the invariant logic formula expresses the result of operation of an input signal of the controller equaling the result of an output signal of the controller.

5. The method for debugging a program of a programmable logic controller as claimed in claim 4, further comprising, before the program checking step, classifying the program into many modules.

6. The method for debugging a program of a programmable logic controller as claimed in claim 4, further comprising, before the program checking step, simplifying the program.

7. The method for debugging a program of a programmable logic controller as claimed in claim 4, wherein the invariant logic formula includes a series logic and a parallel logic.

8. The method for debugging a program of a programmable logic controller as claimed in claim 7, further comprising, before the program checking step, classifying the program into many modules.

9. The method for debugging a program of a programmable logic controller as claimed in claim 7, further comprising, before the program checking step, simplifying the program.

10. The method for debugging a program of a programmable logic controller as claimed in claim 1, wherein the program error is saved in a buffer.

11. The method for debugging a program of a programmable logic controller as claimed in claim 10, further comprising, before the program checking step, classifying the program into many modules.

12. The method for debugging a program of a programmable logic controller as claimed in claim 10, further comprising, before the program checking step, simplifying the program.

13. The method for debugging a program of a programmable logic controller as claimed in claim 1, wherein the position and timing of the program error are displayed on a human-machine interaction interface means upon the program checking step having stopped.

14. The method for debugging a program of a programmable logic controller as claimed in claim 13, further comprising, before the program checking step, classifying the program into many modules.

15. The method for debugging a program of a programmable logic controller as claimed in claim 13, further comprising, before the program checking step, simplifying the program.
